(19) United States
(12) Patent Application Publication
(10) Pub. No.: US 2002/0078075 A1
(43) Pub. Date: Jun. 20, 2002

(54) System, method, and program product for prioritizing synchronizable data

(76) Inventors: James C. Colson, Austin, TX (US); Brian Lee White Eagle, Austin, TX (US)

Correspondence Address: Russell D. Culbertson, Shaffer & Culbertson, L. L. P., Bldg. One, Ste. 360, 1250 Capital of Texas Hwy. S., Austin, TX, 78746, US

(21) Appl. No.: 09/737,341

(22) Filed: Dec. 15, 2000

(51) Int. Cl. G06F 12/00

(52) U.S. Cl. 707/204

(57) ABSTRACT

A prioritization system (10) utilizes a number of predefined prioritization schemes and a collection of scheme effecting data (12) by which the various predefined prioritization schemes may be effected. Once a user selects a prioritization scheme from the number of available schemes, the prioritization scheme is preferably stored for use in later requested synchronization or sync sessions. When the user requests a sync session to synchronize data at a client device (44, 45, 46) with data stored at another designated device, the prioritization system applies the user's selected prioritization scheme along with the required scheme effecting data and any other necessary parameters to produce a prioritized data set. The data at the client device (44, 45, 46) may then be synchronized to the highest priority data as indicated by the prioritized data set.

### TECHNICAL FIELD OF THE INVENTION

The invention relates to data synchronization between data stored at separate devices. More particularly, the invention relates to a system and method for prioritizing data which may be synchronized. This prioritization accommodates differences in data storage capabilities between different devices.

### BACKGROUND OF THE INVENTION

There has been a proliferation of different types of devices which have data storage capacity for locally storing certain useful information. For example, mobile telephones may include a data storage element for storing information such as telephone mumbers for different individuals. Internet enabled mobile telephones may also include sufficient storage capacity for storing email addresses and addresses for favorite Internet locations. It is likely that this proliferation of devices having local data storage capabilities will continue and perhaps even accelerate.

Any time data is stored at different physical locations, there is the problem of ensuring that the data remains consistent across the different physical locations. For example, an individual's telephone number may change and the new number may be recorded in a company database. However, the individual's old telephone number may have been stored locally in a mobile device such as a mobile telephone and remain unchanged. Thus, the two data storage arrangements, the mobile phone and the company database, may contain inconsistent data. In order to make the data consistent between the two data storage arrangements, the individual's new telephone number must be entered into the mobile device. Making data consistent between different data storage locations is referred to as “data synchronization” or simply “synchronization.”

A problem in data synchronization arises when data storage capabilities vary between different data storage devices. Returning to the mobile telephone example, the storage capability associated with the mobile telephone may be limited to entries for 99 individuals or business entities with each entry limited to two different telephone numbers. In contrast, the company's main database may include contact information for a virtually unlimited number of individuals or business entities and may include a large number of alternative contact telephone numbers for each individual or business entity. Assume in this example that the mobile telephone user desires to synchronize the data stored locally at the telephone to the data in the company database. Because the mobile telephone simply does not have a data storage resources to hold all of the data in the company database, the data stored at the telephone can only be synchronized to a relatively small subset of the data in the company database. But how is the small subset of data from the company database to be determined? Even if the telephone user specifies the subset of individuals or entries in the company database to which they want their local data synchronized, there remains the problem of which telephone numbers to use from the main database. This data synchronization problem is not limited to the mobile telephone situation set out above for purposes of example. Rather the problem exists in each situation in which a device having a given data storage capacity is synchronized to a device having a relatively larger data storage capacity.

### SUMMARY OF THE INVENTION

It is an object of the invention to provide a system and method for implicitly selecting data to be used in data synchronization. More particularly, it is an object of the invention to provide a system and method for prioritizing synchronizable data to be used in a data synchronization process. It is also an object of invention to provide a program product for prioritizing data to be used in data synchronization.

These objects are accomplished in a system utilizing a number of predefined prioritization schemes and a collection of scheme effecting data by which the various predefined prioritization schemes may be effected. Once a user selects a prioritization scheme from the number of available schemes, the prioritization scheme is preferably stored for use in later requested synchronization or sync sessions. When the user requests a sync session to synchronize data at a client device with data stored at another designated device, the present invention applies the user's selected prioritization scheme along with the required scheme effecting data and any other necessary parameters to produce a prioritized data set. The data at the client device may then be synchronized to the highest priority data as indicated by the prioritized data set. This synchronization may be performed according to the user's selected prioritization scheme with no further intervention by the user.

In the following description and claims, a device having data to be synchronized to data stored at another location will be referred to as a “client device.” The phrase “scheme effecting data” will be used to describe all data which may be required in effecting a particular selected prioritization scheme. Thus, scheme effecting data may include not only metadata associated with certain objective data but also the objective data itself. As used here and elsewhere in this disclosure, the phrase “objective data” refers to the actual data to which a client device is to be synchronized, and “metadata” refers to data which the present system collects about the objective data in order to effect the various predefined prioritization schemes. For example, a database entry may include four separate fields. A first field contains an individual's name and a second field contains a telephone number for the individual. A third field contains a value indicating the frequency with which the entry is accessed, and finally a fourth field contains a time and date indicating when the entry was last accessed. In this example, the individual's name and telephone number stored in the first two fields represents objective data, while the access frequency and access date data stored in the third and fourth fields represents metadata associated with the entry.

The method according to the invention includes responding to a sync session request by reading a selected prioritization scheme. The selected prioritization scheme comprises the predefined prioritization scheme which has been selected by or for the particular user initiating the request. This prioritization scheme reading step is preferably performed by scheme reading program code executed by a suitable data processing device.

The present method next includes retrieving the scheme effecting data required by the selected prioritization scheme. Once the selected prioritization scheme and all scheme effecting data is retrieved, the method then includes producing a prioritized data set based on the selected prioritization scheme and preferably on a plurality of sync session parameters. These sync session parameters may include, for example, parameters of the subject client device and parameters of the communications link over which the synchronization session is to be carried out. The step of retrieving the scheme effecting data is performed by data retrieval program code while the prioritization step is performed by prioritization program code both executed on a suitable data processor.

A user may preferably choose from a number of available prioritization schemes. These available prioritization schemes may be stored in a suitable storage device accessible by the user through a suitable interface. The prioritization schemes for a user are preferably chosen in a separate scheme selection process prior to a sync session request and stored in a user preference database to be retrieved or read in response to a sync session request. The prioritization scheme selection and storage are controlled by scheme selection program code executed on a data processor.

Alternatively to storing selected prioritization schemes in a user preference database and then reading the selected scheme from the database in response to a sync session request, the selected prioritization scheme may be included in the sync session request itself. In this case, the method includes reading the selected prioritization scheme from the sync session request. This reading step is to be considered equivalent to the alternative arrangement in which the selected scheme is stored in a user preference database and read from the database in response to the sync session request.

The step of producing the prioritized data set based on the prioritization scheme and applicable sync session parameters is preferably performed using a prioritization formula unique to the given scheme and session parameters. A database may be used to store the various prioritization formulas needed to effect the various prioritization schemes for different combinations of session parameters. The preferred form of the invention includes a step of retrieving a prioritization formula from a prioritization formula storage arrangement which stores the formula database. As in the other steps in the present process, the prioritization formula retrieval step is preferably performed by a suitable processing device under the control of operational software, in this case formula retrieval program code. The retrieved prioritization formula is then applied to produce the desired prioritized data set. The client device for which the sync session request was initiated may then be synchronized to this prioritized data set to ensure that only the highest priority data is stored on the limited storage resources of the client device.

It will be noted that the selected prioritization scheme is independent of the client device having data to be synchronized. That is, the user's selected prioritization scheme will be followed regardless of the type of client device having data to be synchronized.

The preferred form of the invention supports numerous different types of client devices and numerous different types of communication links. In order to support the numerous combinations of client devices and communications protocols, the method preferably includes the step of recognizing request characteristics from the received sync session request. The method then includes retrieving a number of actual sync session parameters dictated by the recognized request characteristics. For example, the method may include recognizing that the sync session request is submitted for a client device comprising a mobile telephone. Having recognized the mobile telephone, the method then includes retrieving information regarding the mobile telephone such as storage capacity and perhaps storage format, for example. The storage capacity and storage format in this particular example represent actual sync session parameters which will be used in the prioritization of raw objective data to produce the desired prioritized data set. However, those skilled in the art will appreciate that a prioritization system according to the present invention may be implemented in a fashion that does not require actual sync session parameters in the prioritization process.

As with the other method steps performed according to the invention, the step of recognizing request characteristics from the received sync session request is performed by operational software being executed on a suitable data processor as is the step of retrieving the sync session parameters based upon the recognized request characteristics. Specifically, the recognition step is performed by characteristic recognition program code and the session parameter retrieval step is performed by parameter retrieval program code.

The method according to the invention is implemented through a system of hardware devices including one or more data processing devices for executing the various operational software and performing the various method steps as directed by the software. This system includes a sync engine component along with storage arrangements for storing prioritization schemes and scheme effecting data. The sync engine component operates under the control of operational software or computer program code including the various software described above in connection with the method steps performed according to the invention. The scheme effecting data and preferably any objective data not included in the scheme effecting data is stored in a data store storage arrangement which is accessible to the sync engine component. In one preferred form of the invention, selected prioritization schemes are stored centrally in a data storage arrangement including entries for all prioritization system users. Each entry in this user preference storage arrangement includes the user's selected prioritization schemes.

The data prioritization according to the present invention has numerous benefits. Perhaps most importantly, the prioritization facilitates rational data synchronization between a client device having a relatively limited data storage capacity and a data storage system having a relatively higher data storage capacity. Also, once a user selects a prioritization scheme, the scheme may be applied to a number of different client devices storing data to be synchronized. The prioritization is performed implicitly according to the selected prioritization scheme without further intervention by the user and without requiring that the user explicitly select data to which the client device data is to be synchronized.

These and other objects, advantages, and features of the invention will be apparent from the following description of the preferred embodiments, considered along with the accompanying drawings.

### BRIEF DESCRIPTION OF THE DRAWINGS

FIG. 1 is a diagrammatic representation of a system embodying the principles of the invention for prioritizing synchronizable data.

FIG. 2 is a representation of a preferred arrangement of data used in the prioritization process according to the invention.

FIG. 3 is a flowchart showing the scheme selecting process.

FIG. 4 is a flowchart showing the prioritization process according to the invention.

### DESCRIPTION OF THE PREFERRED EMBODIMENTS

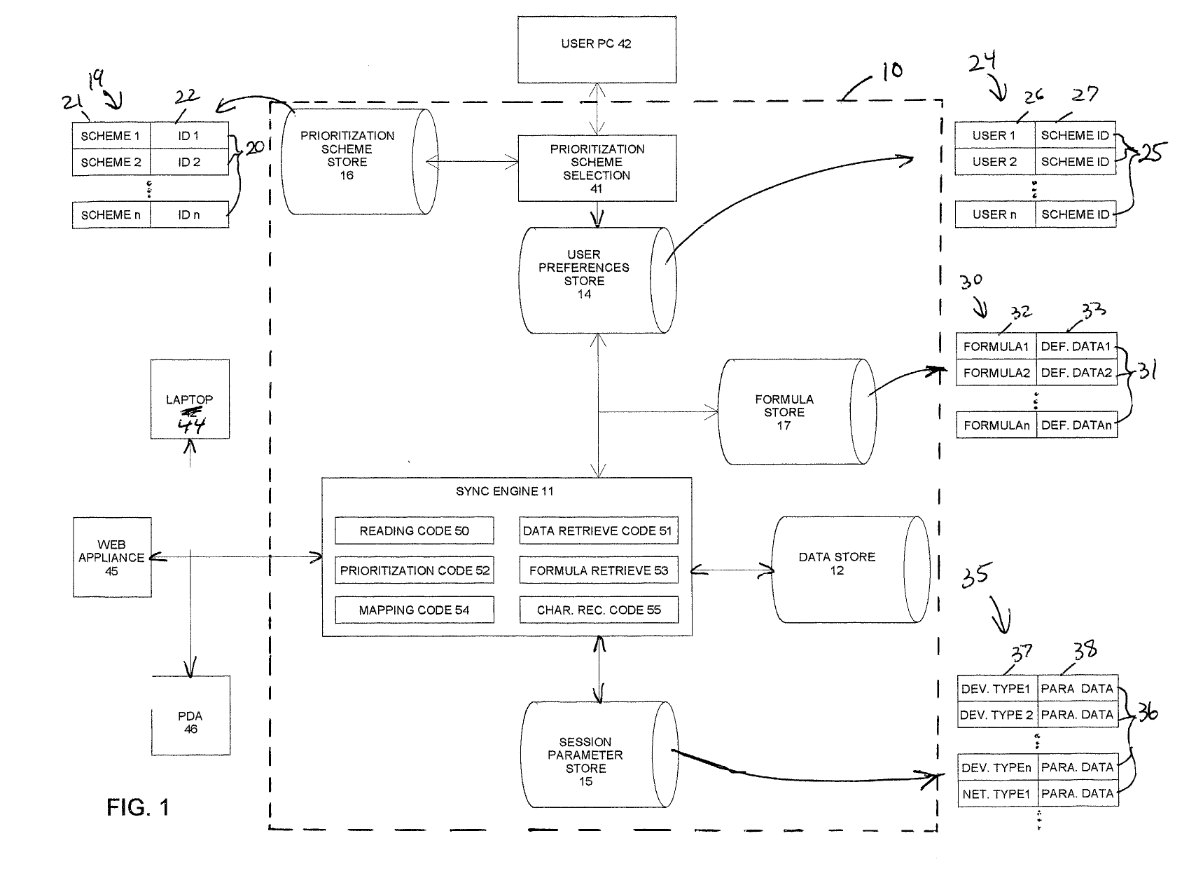

Referring to FIG. 1, a prioritization system 10 embodying the principles of the invention includes a sync engine component 11 and a data store storage arrangement 12 accessible to the sync engine component. System 10 also preferably includes a user preference storage arrangement 14 accessible to the sync engine component. The form of the prioritization system shown in FIG. 1 further includes a device parameter storage arrangement 15, an available prioritization scheme storage arrangement 16, and a prioritization formula storage arrangement 17.

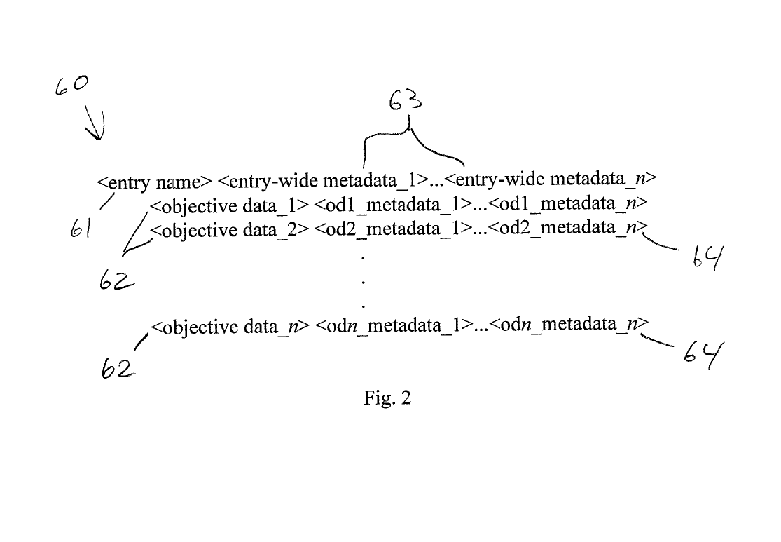

Sync engine component 11 comprises a suitable data processing device operating under the control of computer software code as will be discussed further below. The various storage arrangements each comprise a collection of data stored on one or more distinct data storage devices which are each interfaced with the data processing device through which sync engine component 11 is implemented. For purposes of example, scheme storage arrangement 16 stores a table 19 having a number of entries 20 each including a scheme name field 21 and a scheme identifier field 22. User preference storage arrangement 14 stores a table 24 having a number of entries 25 with each entry including a user identifier field 26 and a selected prioritization scheme identifier field 27. Prioritization formula storage arrangement 17 stores a table 30 having a number of entries 31. Each entry 31 includes a formula field 32 storing a prioritization formula and further includes a series of fields 33 storing formula defining data which defines the formula to apply to a given set of circumstances in a sync session. Session parameter storage arrangement 15 is illustrated as storing a table 35 having a number of entries 36. Each entry 36 includes a field 37 for storing a device type, network type, or other characteristic type and further includes one or more fields 38 for containing data on various physical parameters associated with the respective characteristic type. Data store storage arrangement 12 will be discussed further below with respect to FIG. 2.

FIG. 1 shows a prioritization scheme selection component 41 included in prioritization system 10. Scheme selection component 41 comprises a suitable data processing device operating under the control of certain program code. The data processing device through which scheme selection component 41 is implemented is shown in FIG. 1 connected to a user's personal computer 42. As will be discussed further below, prioritization scheme selection component 41 cooperates with the available prioritization scheme storage arrangement 16 and preferably the user preferences storage arrangement 14 to enable a user to select and store one or more desired prioritization schemes according to the invention.

In addition to user personal computer 42 three different client devices are also illustrated in FIG. 1 as being in communication with prioritization system 10. One client device comprises a laptop computer 44 and represents a client device having a slightly limited data storage capacity. An Internet appliance 45 represents a client device having a more limited data storage capacity. Finally, a PDA (personal digital assistant) 46 represents a client device having a very limited data storage capacity.

It will be appreciated by those skilled in the art that the particular arrangement of devices showing FIG. 1 is shown only for purposes of example and is not intended to limit the accompanying claims to that specific configuration. In particular, there may be many different types of client devices which may communicate with prioritization system 10 according to the invention. These other devices may include telephones, regular desktop personal computers, and virtually any other type of device that includes a data storage element containing data which may be synchronized to data stored in another physical location. Also, although user's personal computer 42 is shown as communicating with scheme selection component 41, it will be appreciated that any of the client devices 44, 45, or 46 may be used to interface with the scheme selection component in various implementations of the invention. Furthermore, the various data storage arrangements 12, 14, 15, 16, and 17 illustrated for purposes of better describing the invention need not be separate databases. Rather the various databases may be joined in a single relational database or other suitable database arrangement for storing the data required according to the invention. Those skilled in the art will appreciate many different types of data storage arrangements which may be used to implement the present prioritization system.

In describing system 10 illustrated in FIG. 1 and in describing the operation of the system below, it is convenient to refer to various data processing devices and computer software or program code executed by the various data processors. It will be appreciated, however, that current distributed computing or processing environments allow various portions of software to be executed across many different networked processing devices to achieve a given data processing goal. Generally, the invention is not limited to any particular data processing architecture or topology. The various method steps or functions described below may be performed on a single data processing device or may be distributed across many different data processing devices. These data processing arrangements are to be considered equivalents for the purposes of the following claims.

Sync engine component 11 includes or utilizes several different software components which each perform one or more functions according to the invention. One such software component comprises scheme reading program code 50. The function of this scheme reading program code depends generally upon the manner in which a prioritization scheme for a user is communicated in a sync session request. In the form of the invention illustrated in FIG. 1, a sync session request does not include the selected prioritization scheme but only a user identifier. The scheme reading program code 50 in this case causes the data processor to respond to the sync session request by reading the user identifier and using that identifier to retrieve the user's selected prioritization scheme from user preference storage arrangement 14. Alternatively, the sync session request may actually include an identifier for the selected prioritization scheme and the scheme reading program code causes the processor to read the scheme identifier from the sync session request. In further alternatives, the user's selected prioritization scheme may be determined from user preference data residing at the device from which the sync session request is initiated.

Other software elements included in sync engine component 11 include data retrieval program code 51 and prioritization program code 52. Data retrieval program code 51 retrieves scheme effecting data from data store storage arrangement 12. This scheme effecting data comprises data necessary in effecting the user's selected prioritization scheme. Prioritization program code 52 applies the selected prioritization scheme and a plurality of sync session parameters to produce a prioritized data set. In particular, prioritization program code 52 applies a retrieved prioritization formula to the retrieved scheme effecting data and session parameters to produce the prioritized data set. This prioritization formula is retrieved by formula retrieval program code 53 also associated with sync engine component 11. Formula retrieval code 53 retrieves a particular prioritization formula from formula storage arrangement 17 based on the selected prioritization scheme and a number of sync session parameters. These sync session parameters are retrieved from session parameter storage 15 by parameter mapping program code 54 as dictated by characteristics recognized from the sync session request. Preferably, request characteristic recognition program code 55 recognizes the various characteristics from the received sync session request.

Data store storage arrangement 12 shown in FIG. 1 preferably comprises a single relational database which may be implemented in the extensible markup language (“XML”), and stores both objective data to which data at a client device 44, 45, or 46 may be synchronized, and also metadata associated with that objective data. FIG. 2 shows a format for an entry in this preferred data store storage arrangement 12. For each entry 60 there includes an entry name field 61 along with multiple fields 62 for objective data. In addition to the entry name field 61 and fields 62 of objective data, additional fields 63 are devoted to entry-wide metadata. This entry-wide metadata comprises metadata which relates to the entry as a whole and not just certain objective data fields 62. Additional fields 64 for metadata are included for each field 62 of objective data. These metadata fields 64 store metadata specific to the particular objective data stored in the respective field 62.

It will be appreciated that numerous different database arrangements may be used to implement the data store storage arrangement 12 according to the invention. The variations are not only limited to variations in the structure of a single database but also include variations which rely on multiple separate databases. The single data store database form of the invention requires a copy of all objective data which may be targeted in a synchronization session. For example, if the prioritization system according to the invention supports synchronization to a personal address book and to a company database which includes contact information for individuals, both the objective data from a personal address book and objective data from a company database must be stored in the single database version of data store 12. However, in some implementations of the invention, it may be undesirable to maintain copies of objective data which may be targeted in a synchronization session. Thus, alternative implementations of data store storage arrangement 12 may include a database for storing only metadata required to support the various prioritization schemes available in the system, and may rely on access to the objective data stored in additional databases. In the example described above relating to a user's person address book, data store storage arrangement 12 would, in this alternate implementation, include a database containing metadata for the objective data stored in a personal address book, and the personal address book database itself would be the source of objective data in the data store storage arrangement 12. In this way, databases storing objective data independent of the prioritization system are essentially incorporated into the data store storage arrangement of the present invention.

In either implementation of the data store storage arrangement 12 described above, the system according to the invention includes metadata collection program code for collecting the metadata required to support the various prioritization schemes available in the system. The manner in which metadata is collected will depend upon the nature of the metadata. For example, where the metadata comprises an indicator for the number of times certain objective data is accessed, the metadata collection program code includes a component that detects when the particular objective data is accessed and a counter component that increments a metadata database field value (such as field value 63 or 64 in FIG. 2) for each access. For another example, assume that the prioritization system 10 requires metadata comprising the creation time for objective data. In this case, the metadata collection program code may include a component that detects when the particular objective data is created and records that creation time in a metadata database field (such as field 63 or 64 in FIG. 2) for the particular objective data. Those skilled in the art will appreciate many other types of metadata which may be required to implement a prioritization scheme according to the invention. Operational program code for collecting any of this metadata will be apparent to those skilled in the art.

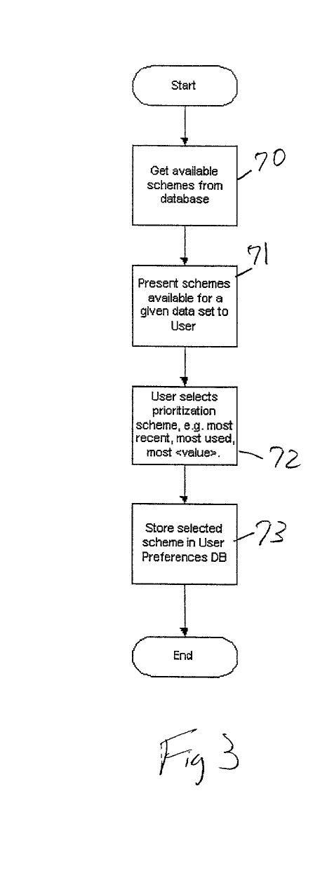

Although prioritization system 11 may include the default prioritization schemes which are applied when a user has not selected a desired scheme, it is preferable that a user be allowed to select their desired scheme or schemes for use with different devices or in different situations. Referring to FIG. 3, a preferred prioritization selection process starts with a user initiating the selection process implemented through scheme selection program code associated with scheme selection component 41 shown in FIG. 1. The first step in the preferred scheme selection process is shown at process block 70 in FIG. 3. At this step the operational software causes the component 41 to retrieve names or other identifiers for all of the available prioritization schemes from scheme storage arrangement 16 shown in FIG. 1. As shown at process block 71 in FIG. 3, this information on available prioritization schemes is preferably presented graphically to the user using drop-down menus or any other suitable graphical presentation. It will be appreciated that the prioritization schemes may be specific to different types of objective data and thus a given scheme may not be enabled for a given type of objective data. For example, for telephone contact data in a suitable prioritization scheme may be “most frequently used” or “most recently used.” However, these prioritization schemes may be inappropriate for other types of objective data, such as for example, objective data relating to financial investments such as stocks or mutual funds. Thus, the scheme selection process preferably does not allow a user to choose a nonsensical prioritization scheme for use in synchronizing a particular type of objective data.

As shown at process block 72 in FIG. 3, once the available prioritization schemes are presented for selection, the user selects a desired prioritization scheme. This selection causes the operational software associated with scheme selection component 41 to store the selected scheme in user preference storage arrangement 14 shown in FIG. 1. This selected scheme storage step is shown at process block 73 in FIG. 3. Depending upon the implementation, further information such as the types of objective data for which the selected scheme is to be used may also be stored in user preference storage arrangement 14. A user may also be allowed to choose or select different prioritization schemes to use alternatively for a given type of data depending upon the situation. These different prioritization schemes may be invoked automatically by rules defined by the user or manually by a user through a suitable interface.

As indicated above in reference particularly to FIG. 1, the scheme selection process may be implemented through a centralized process operating with the sync engine component 11 and perhaps through the same data processing hardware. However, the scheme selection process may also be distributed to software executed on a remote device such as the user's personal computer 42 or a client device 44, 45, or 46 shown in FIG. 1. In this embodiment of the invention, prioritization system 10 may not include the centralized user preference storage arrangement 14, but rely on user preferences selected at the requesting device and communicated to prioritization system 10.

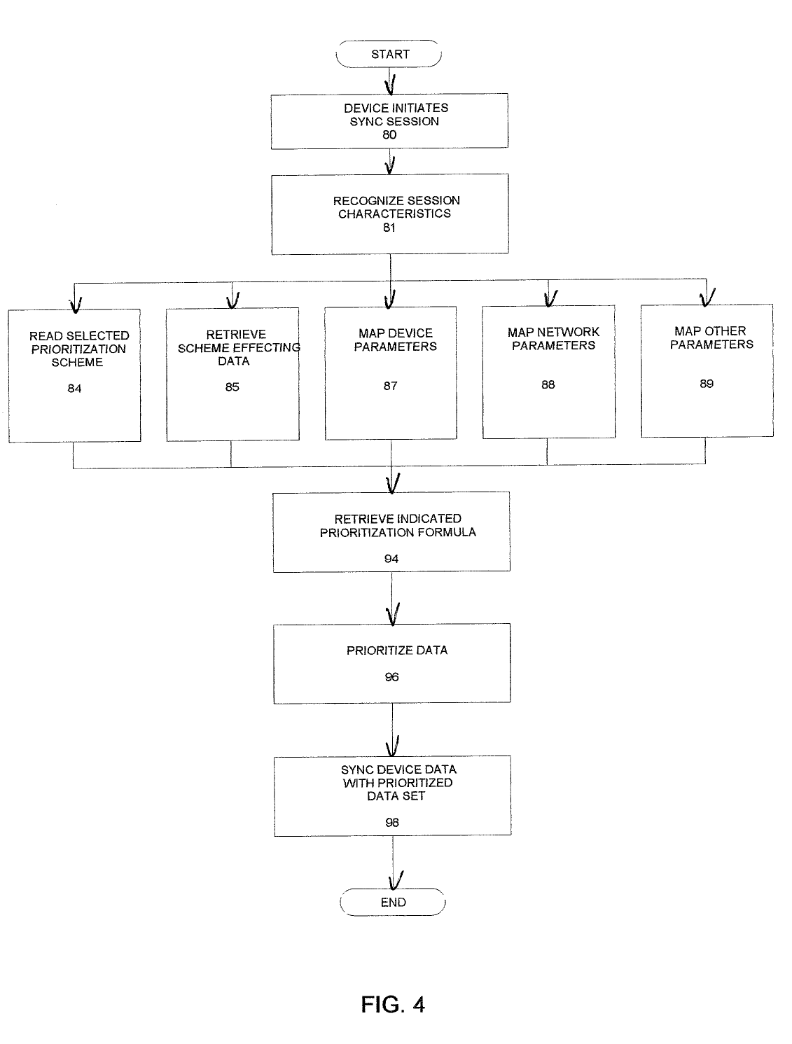

FIG. 4 illustrates the flow of the data prioritization process according to the present invention. As shown at process block 80, the session begins when a device initiates a sync session with sync engine component 11 (FIG. 1). In this initiation step, a sync session request is communicated to the sync engine component 11. It will be noted that this sync session request may be communicated in response to a manual input entered at the initiating device or may be communicated automatically under operational program control. For example, an initiating device (such as PC 42, laptop 44, appliance 45, or PDA 46 in FIG. 1) may include a button or other input arrangement dedicated for manually initiating a sync session request. Alternatively, the initiating device may be programmed to automatically communicate a sync session request periodically or in response to some other event.

It should also be appreciated that the device initiating the sync session request is not necessarily the client device physically storing the data to be synchronized. That is, a user operating the personal computer 42 in FIG. 1 may initiate a sync session request for synchronizing data at their PDA or telephone. Also, those skilled in the art will appreciate that the manner in which the sync session request is initiated may vary widely within the scope of the present invention. For example, in the case of Internet enabled devices having browser capability, a sync session may be initiated through the browser software running on a client device and may rely entirely on the Internet for communications between the client device and sync engine component 11 (FIG. 1). Alternatively, the initiating device may include dedicated software which provides a user interface for sending a sync session request. In this case dedicated software at the initiating device includes the ability to communicate the sync session request to the sync engine component through a suitable communications link.

Referring still to FIG. 4, the prioritization method according to the invention next preferably includes the step of recognizing session characteristics as shown at process block 81. The session characteristics such as the identification for the user, device type, network type, and other necessary information may be communicated or made available to sync engine component 11 (FIG. 1) in number of different ways. For example, the sync session request may simply include a format which includes all of this session characteristic information and the information may simply be read from the sync session request. Alternatively, at least some of the session characteristics may be recognized from communications with the initiating device where the initiating device is the device for which the synchronization session is requested. Both the device type and network type, for example, may be detected from information necessarily communicated with the sync session. Thus, system 10 shown in FIG. 1 preferably comprises session characteristic recognizing program code for detecting these various session characteristics from the communications associated with the sync session request.

In the flowchart shown in FIG. 4, once the session characteristics are recognized from the sync session request, the process separates into a series of operations for retrieving information required to produce the desired data prioritization. As shown at process block 84, the sync engine component reads the user selected prioritization scheme from the user preference storage arrangement (14 in FIG. 1) or reads the selected scheme from the request if the scheme is identified in the request itself. This scheme reading step is preferably performed by the scheme reading program code included in sync engine component 11 as described above with reference to FIG. 1.

As indicated at process block 85 in FIG. 4, the sync engine component 11 also retrieves the scheme effecting data from data store storage arrangement 12 shown in FIG. 1. This step is performed by the data retrieval program code 51 included in the sync engine component 11 as discussed above with reference to FIG. 1. The particular scheme effecting data which must be retrieved will be dependent upon the user's selected prioritization scheme and may include metadata only or both metadata and objective data. In the preferred form of the invention, this data retrieval step 85 also retrieves all of the objective data to be used in the actual data prioritization. Alternatively, just scheme effecting data may be retrieved this point and the actual objective data may be retrieved only has necessary in the actual data synchronization process performed after data prioritization according to the present invention.

Process blocks 87, 88, and 89 each represent steps for retrieving actual sync session parameters which may be required to implement or effect the selected prioritization scheme. For example, as shown in process block 87, the method includes retrieving device parameters dictated by the device type determined or recognized from the sync session request. These device parameters may include storage capacity, interface type, and other parameters associated with the client device. At process block 88, the prioritization method also includes retrieving actual network parameters dictated by the network type determined or recognized from the sync session request received at process block 80. These parameters may include bandwidth, reliability, and other parameters associated with the communications link to the client device. Process block 89 is shown in FIG. 4 to indicate that other actual parameters may be required based on the session characteristics recognized or determined from the sync session request. These session parameters may be any parameters which are implicated in a prioritization scheme supported by the present system. All of these parameters are retrieved using the parameter mapping code 54 executed on the system hardware.

After sync engine component 11 (FIG. 1) waits for all of the required data to be read or retrieved , the method proceeds to the step of retrieving the correct prioritization formula from prioritization formula storage arrangement 17 (FIG. 1) as shown at process block 94 in FIG. 4. This step may include simply querying the prioritization formula storage arrangement 17 in FIG. 1 with all of the formula determining information such as the prioritization scheme and sync session parameters. Prioritization formula storage arrangement 17 responds to the query by returning the prioritization formula determined by the selected prioritization scheme and session parameters.

As shown at process block 96, sync engine component 11 (FIG. 1) then prioritizes the data to which the client device is to be synchronized by simply applying all of the collected scheme effecting data and session parameters to the retrieved prioritization formula. This step produces a prioritized data set to which the client device indicated in the sync session request may be synchronized. It will be appreciated that the prioritized data set may not be stored in a separate table or database of objective data. Rather, the prioritized data set may comprise a list of handles or identifiers to various objective data entries in data store storage arrangement 12 shown in FIG. 1. Once the prioritized data set is available, the process may proceed to the step of actually synchronizing the data at the client device for which the request was initiated. This synchronization step may be performed in any suitable manner and preferably in accordance with a synchronization standard such as the SyncML standard.

The following two examples help describe the elements, functions, and features of the present invention. The first example relates to a synchronization session between a user's mobile telephone and the user's personal address book stored on a personal computer. Assume the user's personal address book has the capability of storing a maximum of the 500 entries with each entry including physical address information for two different locations, up to four telephone numbers for each entry, and Internet information such as a home page address and one or more email addresses. The second example refers to a synchronization session between the same user's PDA and the user's same personal address book referenced in the first example. Both examples will be discussed using the preferred form of the invention in which data store storage arrangement 12 in FIG. 1 stores both objective data and metadata. Also, both examples assume that the user has previously selected a prioritization scheme entitled “most used” for prioritizing data to be stored at the telephone and the PDA, or has had that scheme selected for them in some fashion.

In the first example assume that the mobile telephone has a storage capacity for 99 entries with each entry having a maximum of two telephone numbers. Also, assume that the telephone is a digital telephone which transmits and receives data in digital format across a digital telecommunications network. The telephone has a function menu through which the user may select a “sync session” from among other functions performed by the telephone.

The user first initiates the synchronization session by selecting the sync session function from the telephone's function menu. The telephone responds to the selection by producing a sync session request and transmitting the request across the telecommunications network to the sync engine component (11 in FIG. 1). This transmission includes dialing up a resource associated with the sync engine component 11 in FIG. 1 and communicating the sync session request once the connection His made. Sync engine component 11 receives the request and preferably detects characteristics associated with the request as discussed above with reference to process block 81 in FIG. 4. In this example, sync engine component 11 detects the identity of the user, the particular type of device from which the request is initiated, and the type telecommunications network over which the sync session is to be conducted.

The prioritization process according to the invention next proceeds to the parallel processes shown in process blocks 84, 85, 87, 88, and 89 of FIG. 4. Sync engine component 11 in FIG. 1 reads the user's selected prioritization scheme (“most used”) from the user preference database 14 and also retrieves the scheme affecting data from data store 12. In this case, the scheme affecting data includes metadata comprising a frequency of use indicator or counter for each entry in the user's address book and each telephone number in each entry of the address book. The frequency of use indicator for the entry would be stored in an entry-wide metadata field such as field 63 in FIG. 2 and the frequency of use indicator for each number in the entry would be stored in a objective data specific field such as field 64 in FIG. 2. Sync engine component 11 also maps session parameters dictated by the characteristics recognized from the received sync session request. For example, parameter mapping code 54 associated with sync engine component 11 looks up and retrieves the storage capacity and data format for the requesting telephone. The parameter mapping code also looks up and retrieves parameters relating to the communication protocols along with the bandwidth associated with the recognized telecommunications network.

Once all the data is retrieved by sync engine component 11, the sync engine component uses the retrieved data to retrieve the proper prioritization formula from formula storage arrangement 17 shown in FIG. 1. A simple formula to implement the “most used” scheme would order all entries by the frequency with which the entries have been used and within each entry, order the telephone numbers by the frequency with which they have been used. The formula would then take the first N entries in the ordered set where N equals the number of entries the telephone can store.

After retrieving the indicated prioritization formula, sync engine component 11 applies the formula to the collected data and session parameters to produce the desired prioritized data set. This data set lists the 99 most frequently used entries from the user's address book and for each entry the most frequently used two telephone numbers associated with the particular entry. Finally, sync engine component 11 initiates communications back to the telephone across the telecommunications network to synchronize the data at the telephone to the prioritized data set according to a suitable synchronization protocol.

For the second example, assume that the PDA is Internet enabled through wireless Internet communications and includes Web browser software. Also assume that the PDA has storage capacity for 400 address book entries with each entry including a single physical address, up to three telephone numbers, and one email address.

To accommodate a sync session with this Internet enabled PDA, the synchronization system 10 according to the invention includes an Internet server which provides an interface between the user's PDA and sync engine component 11. To initiate a sync session request, the user connects to the Internet across their wireless communications arrangement and directs their browser software to the sync system Web site. After the appropriate login procedures, the Web site communicates a page display to the PDA which provides for sync session request submission. For example, the Web page may display a graphic button entitled “initiate sync session.” The user may initiate a sync session request by invoking the sync session request function available through the display on the Web page. Invoking the request causes the browser to communicate a sync session request to the Internet server associated with synchronization system 10.

After the sync session request is communicated from the Internet server associated with synchronization system 10 to sync engine component 11 in FIG. 1, the sync engine component recognizes the identity of the user, the type of device from which the request was initiated, and the communication type over which the request was made. Similar to the telephone example described above, sync engine component 11 then collects data and session parameters required to perform the desired prioritization. This information includes the user's selected prioritization scheme (“most used”), data regarding the PDA capacity and format, and the Internet connection and communication parameters. With this data and session parameter information, sync engine component 11 looks up the appropriate formula for providing the desired prioritized data set. Sync engine component 11 next applies the retrieved formula to the collected data and session parameters to produce the desired prioritized data set. It will be appreciated that even the simple formula described above with reference to the telephone example is applied differently in the case of the PDA since the session parameters are different. For example, because the PDA has storage capacity for more entries than the telephone, the number N in the “most used” formula described above will be set to 400 in the case of the PDA whereas it was set to 99 in the telephone example described above. The formula itself will be different in the case of the PDA because it must also order the address fields according to frequency of use in addition to the telephone number fields. The resulting data set includes the 400 most used entries from the user's address book, the most used address, the three most used telephone numbers, and the most used email address for each entry.

Even though the user's prioritization scheme is the same in both the PDA example and the mobile telephone example, the prioritized data set for the PDA includes different information from the prioritized data set described above in connection with the telephone example. The implicit prioritization provided by the present invention allows the client device to be synchronized to the most appropriate data without intervention by the user other than choosing their desired prioritization scheme.

These two examples are provided in order to better describe the features of the present invention. The invention is by no means limited to these types of client devices or the other characteristics set out in the examples. Many alternative implementations will be apparent to those skilled in the art. For example, although the telephone example relied on wireless communications from the phone to the sync engine, other communication arrangements may be utilized. In the case of the telephone, the phone may have a serial communications port which may be connected to the sync engine hardware with a serial cable. The system according to the present invention supports numerous different types of communications or transport protocols to and from the client devices.

Also, the invention is not limited to the “most used” prioritization scheme mentioned in the examples. Even a “most used” scheme may be implemented in a much more sophisticated fashion than described in the examples. A prioritization scheme within the scope of the present invention may be adapted to “learn” about a user and adapt its behavior accordingly. For instance, a selected scheme may realize that a user uses their voice mail call-in number very often from their mobile phone but never accesses the number from their desktop computer. Therefore, the prioritization system could ensure that the voice mail call-in number is a “most used” number when synchronizing the user's mobile telephone, but not a “most used” number when synchronizing data stored at the user's desktop computer.

The above described preferred embodiments are intended to illustrate the principles of the invention, but not to limit the scope of the invention. Various other embodiments and modifications to these preferred embodiments may be made by those skilled in the art without departing from the scope of the following claims.

1. A method for implicit prioritization of synchronizable data, the method including the steps of:
(a) in response to a sync session request from a client device, reading a selected prioritization scheme associated with a user initiating the sync session request;
(b) retrieving scheme effecting data necessary in effecting the selected prioritization scheme; and
(c) producing a prioritized data set based on the selected prioritization scheme.

2. The method of claim 1 further including the step of:
(a) enabling a user to choose the selected prioritization scheme from the plurality of available prioritization schemes.

3. The method of claim 2 further including the step of:
(a) enabling the user to choose an additional selected prioritization scheme on which the prioritized data set may be based in lieu of the selected prioritization scheme.

4. The method of claim 1 further including the steps of:
(a) retrieving a particular prioritization formula from a plurality of stored prioritization formulas based on the selected prioritization scheme and at least one sync session parameter; and
(b) applying the retrieved prioritization formula to the retrieved scheme effecting data and each sync session parameter to produce the prioritized data set.

5. The method of claim 1 further including the step of:
(a) recognizing request characteristics from the received sync session request, the request characteristics including an identification for the requesting user, the client device type, and the communications type to be used in the requested sync session.

6. The method of claim 5 further including the step of:
(a) using the recognized request characteristics in retrieving the at least one sync session parameter from storage.

7. A computer program product stored on a computer readable medium and executable by a processor for prioritizing synchronizable data, the computer program product including:
(a) scheme reading program code for responding to a sync session request by reading a selected prioritization scheme associated with a user initiating the sync session request;
(b) data retrieval program code for retrieving scheme effecting data necessary in effecting the selected prioritization scheme; and
(c) prioritization program code for producing a prioritized data set based on the selected prioritization scheme.

8. The computer program product of claim 7 further including:
(a) scheme selection program code enabling a user to choose the selected prioritization scheme from the plurality of available prioritization schemes and storing the selected prioritization scheme for the user.

9. The computer program product of claim 7:
(a) further including formula retrieval program code for retrieving a particular prioritization formula from a plurality of stored prioritization formulas based on the selected prioritization scheme and at least one sync session parameter; and
(b) wherein the prioritization program code applies the retrieved prioritization formula to the retrieved scheme effecting data and the at least one sync session parameter to produce the prioritized data set.

10. The program product of claim 7 further including:
(a) characteristic recognition program code for recognizing request characteristics from the received sync session request.

11. The computer program product of claim 10 further including:
(a) parameter mapping program code for using the recognized request characteristics to retrieve the at least one sync session parameter from storage.

12. The computer program product of claim 7 further including:
(a) metadata collection program code for collecting and storing metadata useful in effecting a plurality of prioritization schemes.

13. The computer program product of claim 12 wherein:
(a) the data store program code also collects and stores the objective data to which the client device is to be synchronized.

14. A system for implicit prioritization of synchronizable data, the system including:
(a) a sync engine component for receiving a sync session request from a device, and, in response to the sync session, for reading a selected prioritization scheme which is associated with a system user, and for producing a prioritized data set based on the selected prioritization scheme; and
(b) a data store storage arrangement accessible to the sync engine component, the data store storage arrangement storing objective data to which the client device may be synchronized and further storing metadata related to the objective data and useful in effecting a plurality of available prioritization schemes.

15. The system of claim 14 further including:
(a) an available scheme storage arrangement storing the plurality of available prioritization schemes; and
(b) a scheme selection component enabling a user to choose the selected prioritization scheme from the plurality of available prioritization schemes.

16. The system of claim 15 wherein:
(a) the scheme selection component also enables the user to choose an additional selected prioritization scheme to be used by the sync engine component in lieu of the selected prioritization scheme.

17. The system of claim 14 wherein the sync engine component includes a data retrieval subcomponent for retrieving particular metadata and objective data from the data store storage arrangement based on the selected prioritization scheme.

18. The system of claim 17:
(a) further including a formula storage arrangement storing a plurality of prioritization formulas, each prioritization formula effecting one of the available prioritization schemes for a given combination of sync session parameters to produce a desired prioritized data set;
(b) wherein the sync engine component includes a prioritization formula retrieval subcomponent for retrieving one of the prioritization formulas from the formula storage arrangement based on the selected prioritization scheme and the at least one sync session parameter; and
(c) wherein the sync engine component applies the retrieved prioritization formula to at least the retrieved metadata and to the at least one sync session parameter to produce the prioritized data set.

19. The system of claim 14 wherein the sync engine component includes a request characteristic recognition subcomponent for recognizing request characteristics from the received sync session request.

20. The system of claim 19 wherein the sync engine component includes a session parameter mapping subcomponent for retrieving the at least one sync session parameter as dictated by the recognized request characteristics.

21. The system of claim 14 further including:
(a) a prioritization scheme storage arrangement storing a plurality of available prioritization schemes including the selected prioritization scheme.

22. The system of claim 14 wherein:
(a) the sync engine component comprises a data processing device operating under the control of operational software; and
(b) the data store storage arrangement comprises at least one database stored on at least one data storage device.
